(19) United States
(12) Patent Application Publication
(10) Pub. No.: US 2010/0131497 A1
(43) Pub. Date: May 27, 2010

(54) METHOD FOR DETERMINING WHICH OF A NUMBER OF TEST CASES SHOULD BE RUN DURING TESTING

(76) Inventor: Michael L. Peterson, El Dorado, KS (US)

Correspondence Address: CHRISTOPHER P MAIORANA, PC;LSI Corporation, 24840 HARPER, SUITE 100, ST CLAIR SHORES, MI, 48080, US

(21) Appl. No.: 12/324,344

(22) Filed: Nov. 26, 2008

(51) Int. Cl. G06F 17/30; G06F 7/20

(52) U.S. Cl. 707/722; 707/E17.014

(57) ABSTRACT

A method that includes an example embodiment for evaluating one or more tests comprising the steps of (A) generating one or more queries relating to an aspect of the one or more tests, (B) comparing results received from the one or more queries to scoring data stored in one or more databases, (C) generating a score in response to the comparison, and (D) determining if a first of the tests should be run based on whether the score is above a predetermined value.

### FIELD OF THE INVENTION

The present invention relates to testing generally and, more particularly, to a method and/or apparatus for determining which of a number of test cases should be run during testing.

### BACKGROUND OF THE INVENTION

In a conventional testing organization, the test case management solution does not provide many options for planning aids for the engineer or team leader trying to plan out what test cases will be executed during a given test cycle. Manually examining test cases that have been run before takes a large amount of time by a team. Existing solutions are limited to a manual examination of previous results in an effort to gather data to make useful test plans.

It would be desirable to implement a method and/or system for determining which of a number of test cases should be run during testing.

### SUMMARY OF THE INVENTION

The present invention concerns a method that includes an example embodiment for evaluating one or more tests comprising the steps of (A) generating one or more queries relating to an aspect of the one or more tests, (B) comparing results received from the one or more queries to scoring data stored in one or more databases, (C) generating a score in response to the comparison, and (D) determining if a first of the tests should be run based on whether the score is above a predetermined value.

The objects, features and advantages of the present invention include providing a method and/or apparatus that may (i) determine whether a particular test case should be run, (ii) allow one or more test planners to easily access test cases that have the most benefit in a particular test cycle, (iii) allow one or more test planners to configure one or more thresholds and/or rules that determine whether a particular test should be run, (iv) allow one or more test planners to run a tool that may automatically determine whether or not a test case would be right for a particular test cycle, and/or (v) provide an overall time savings when testing a device and/or design.

### BRIEF DESCRIPTION OF THE DRAWINGS

These and other objects, features and advantages of the present invention will be apparent from the following detailed description and the appended claims and drawings in which:

FIG. 1 is a block diagram illustrating an implementation of an example of the present invention;

FIG. 2 is a block diagram illustrating another implementation of an example of the present invention;

FIG. 3 is a detailed flow diagram shown illustrating an example of the present invention; and

FIG. 4 is a flow diagram shown illustrating a process for testing test cases.

### DETAILED DESCRIPTION OF THE PREFERRED EMBODIMENTS

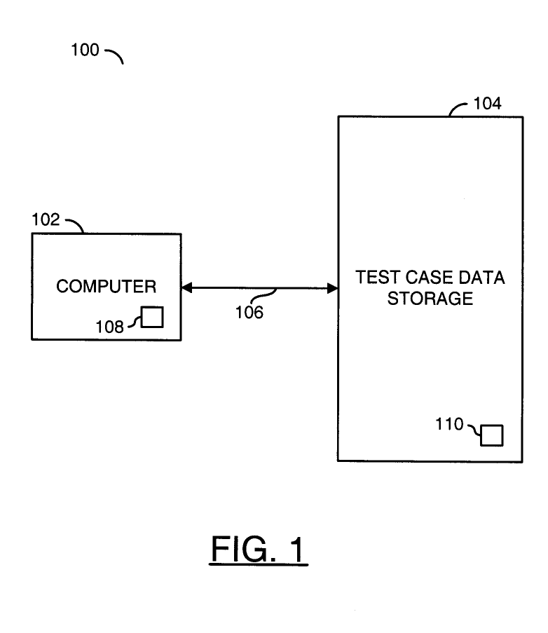

Referring to FIG. 1, a block diagram of a system 100 is shown in accordance with an embodiment of the present invention. The system 100 generally comprises a block 102, a block 104, and a network 106. The block 102 may be implemented as a computer or other processor type circuit. In one example, the computer 102 may be a client workstation. The block 104 may be implemented as a data storage device or data storage circuit. In one example, the block 104 may be implemented as a test case data storage device. For example, the data storage device 104 generally contains or stores one or more databases. In one example, the data storage device 104 may be remotely located from the client workstation 102. The network 106 may be implemented as an ethernet network, a fibre channel network, a wireless network, or other network needed to meet the design criteria of a particular implementation. In one example, the network 106 may be a local intranet, a web-based internet connection, or other appropriate network connection. The data storage device 104 may be implemented as one or more storage devices, such as disc drives, solid state memory, etc.

The system 100 may indicate whether or not a given test routine (e.g., reliability test) should be used in a given test cycle. To determine whether a particular test routine (or test case) should be run (e.g., a determination of an appropriateness of a test), one or more rules (e.g., parameters) may be developed to evaluate a particular test routine. In one example, the rules may be varied from organization to organization. The system 100 may also include a tool 108 (e.g., a software program, application and/or module stored on the computer 102). The tool 108 may be configured to query the data store 104. The tool 108 may generate one or more queries relating to an aspect of a particular test routine. Queries may be generated to evaluate one test routine, two or more test routines in sequence, and/or two or more test routines simultaneously. In one example, the tool 108 may be a module (or particular function on, for example, a drop down menu) within a larger application (e.g., a test case management/execution tool).

The client workstation 102 may implement the tool 108 as a software application. The tool 108 may be used by a test team leader (e.g., a test planner). The test planner may determine which test cases (e.g., from a library of test cases) should be executed for a particular project. In general, the more test cases that are performed, the more reliable the overall testing. When the more testing is performed, the more time and resources are used. A test planner may attempt to maximize the overall reliability of the testing, while minimizing the total number of tests performed. In one example, the test cases may be divided up based on the function that the individual test cases are designed to test. There may be multiple ways to divide and sub-divide the test cases. Each time the test planner uses the tool 108 (e.g., to get an appropriateness score), each test case in the library may be queried. There may be test cases that the test planner knows may not need to be run (e.g., test cases not applicable to the product or design being tested). In such an example, the test planner may query a subset of test cases in the library.

A number of rules (or parameters) may be defined by the test planner. The rules may be varied from organization to organization or from implementation to implementation. The following presents an example of a possible list of rules that may be used to define a numerical value based on one or more particular conditions:
(i) If a particular test case has never been executed before, and the previous execution is less than 6 months old, a score of 1.0 points may be assigned;
(ii) If a particular test case has never been executed before, and the previous execution is more than 1 year old, a score of −0.5 points may be assigned;
(iii) If a particular test case has more failed or more previous runs than passed runs, a score of 0.5 points may be assigned;
(iv) If a particular test case has been run more than 20 times without failing, a score of −0.3 points may be assigned; and/or
(v) If a test case has been run more than 50 times without failing, a score of −5.0 points may be assigned.

While a score defined by a number of points has been described, other values, or numerical representations, may be implemented to meet the design criteria of a particular implementation. For example, the points may be referred to as stars, or other general scoring system. Also, the particular points assigned to each of the example cases may be varied to meet the design criteria of a particular implementation. For example, in case (v), a score lower than −5.0 may be assigned to overweight the condition where a test has never failed. Such a test may safely be skipped. In another example, if a test has never successfully passed, a +5 score may be assigned. In such an implementation, such a test would almost certainly be desirable to be run on a design under test.

The tool 108 may implement a variety of possible rules to accommodate a variety of implementations. The rules may be coded into software and/or hardware. Test planners may be able to configure which rules are executed during a particular query of the data storage device 104. The rules may be saved within a configuration area of the test case management tool (e.g., a configuration file, a database, etc.). There may be multiple different ways to organize how the rules are stored and which rules are actually created and made available to the tool 108.

In one example, the test planner may configure which test cases are returned. For example, the test planner may configure the tool 108 to produce a report that may list the scores each time the data storage device 104 is queried. In another example, the report may list the test cases with scores above a particular threshold. The test planner may also configure the report to show all of the test cases queried. The tool 108 may store the test scores in a location other than to the storage device 104 for performance reasons. For example, the test scores may be stored in a cache memory in the data storage device 104. Certain specific test scores may be limited to the test planner who ran the particular query. The storing of custom scores may have value for historical purposes and may be stored separately from generic scores.

In one example, the rules may be configured by an administrator. For example, each test team may designate an administrator. The administrator may access the rules via a web interface (e.g., an administrator accessible page). The rules may be updated by the administrator. In another example, the rules may be updated by specifically designated users. In one example, the rules may only be accessible by the administrator (or designated user) for updating. In other examples, all users may have access to update such rules. In one example, a log of which user updated the rules may be established and saved in the data storage device 104. An example of such a log may be found in co-pending application Ser. No. 12/323,625, filed Nov. 26, 2008, which is incorporated by reference in its entirety.

The system 100 may also include a program (e.g., a software program 110 stored on the data storage device 104) configured to apply the rules to the test cases. The program 110 may be implemented as a web-based and/or client-server application. In one example, the program 110 may apply the rules to the test cases queried in the data storage device 110. In another example, the program 110 may be stored on the client workstation 102. The tool 108 may query the data storage device 104 for the test cases, and then the program 110 may apply the rules at the client workstation 102. For example, if there are programs that are needed with the test cases in order to test them (e.g., a tool to perform an I/O test against a server, submit made-up data to a web-form, etc.), then the program 110 may be implemented on the client workstation 102. In another example, the program 110 may be implemented on a server somewhere on the network 106 (separate from the workstation 102). The rules may also be applied as a combination initiated from both the client workstation 102 and the data storage device 104. For example, the test planner may submit a test case for automated execution. The test case may then be handled by other data storage devices (e.g., servers) on the network 106.

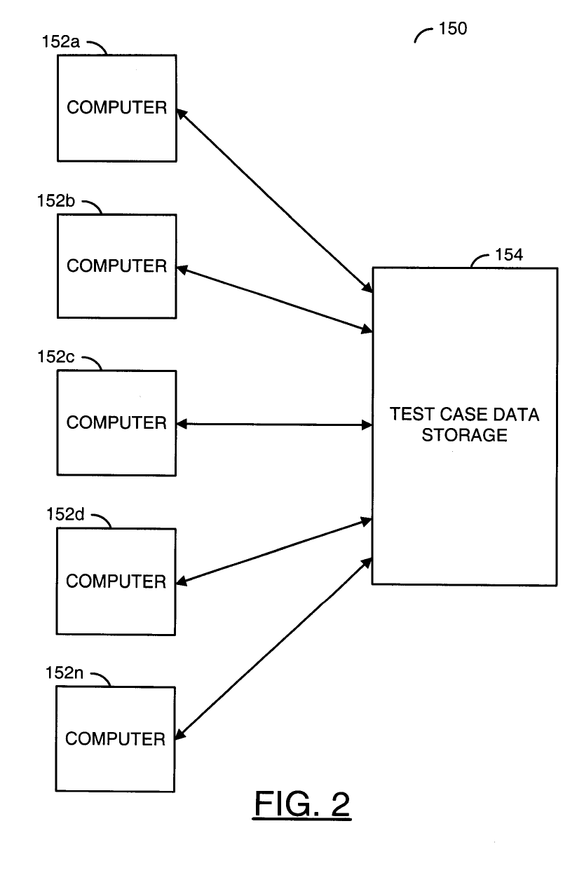

Referring to FIG. 2, a block diagram of the system 150 is shown. The system 150 generally comprises a number of blocks 152a-152n, a block 154, and a network 156. The blocks 152a-152n may be implemented as computers or other types of processor circuits. In one example, the computers 152a-152n may be client workstations. The block 154 may be implemented as a data storage device or other storage circuit. In one example, the block 154 may be implemented as a test case data storage device. The data storage device 154 may store one or more databases. In one example, the data storage device 154 may be remotely located from the client workstations 152a-152n. The network 156 may be implemented as an ethernet network, a fibre channel network, a wireless network, or other type of network needed to meet the design criteria of a particular implementation. In one example, the network 156 may be implemented as a local intranet network, a publically accessible internetwork, or other type of network.

One or more of the client workstations 152a-152n may implement the tool 108. The data storage device 154 may implement the program 110. In another implementation, the tool 108 and the program 110 may be stored on any one of the client workstations 152a-152n. In one example, the client workstations 152a-152n may each be remotely located from one another. In another example, the client workstations 152a and 152b may be part of one test group and the client workstations 152c-152n may be part of other test groups. The tool 108 may be run from any one of the client workstations 152a-152n. A test planner assigned to each of the client workstations 152a-152n may query the data storage device 154.

In one example, the network 156 may connect the client workstations 152a-152n to the data storage device 154. For example, the client workstation 152a may be wirelessly connected to the data storage device 154. In one example, the client workstation 152b may be connected through a network connection to the data storage device 154. In one example, the client workstation 152c may be directly connected to the data storage device 154. Different connections may be implemented for each of the workstations 152a-152n to meet the design criteria of a particular implementation.

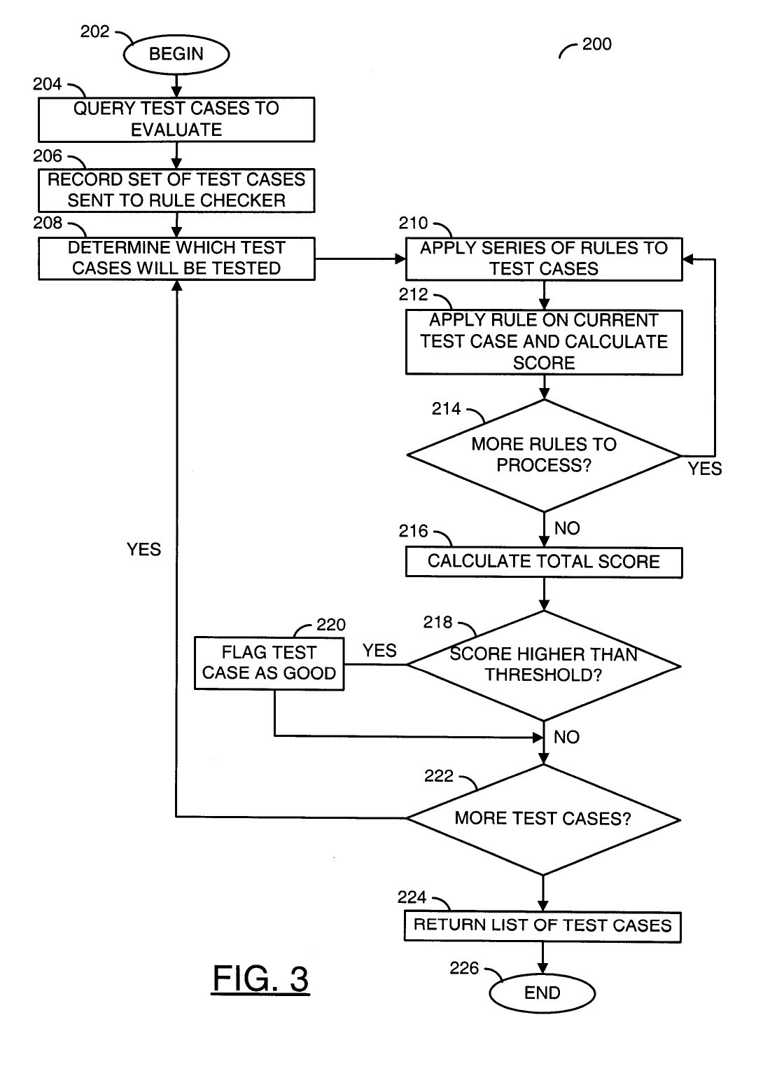

Referring to FIG. 3, a flow diagram of a process 200 is shown in accordance with an embodiment of the present invention. In one example, the process 200 may comprise a step 202, a step 204, a step 206, a step 208, a step 210, a step 212, a step 214, a step 216, a step 218, a step 220, a step 222, a step 224, a step 226. The steps 202-226 may be implemented as steps, states of a state diagram, processes, subroutines, or other types of steps and/or states and/or processes. The step 202 may be implemented to begin the process 200. In the step 204, the process 200 may query for test cases to check. In the step 206, the process 200 may record a set of test cases sent to a rule checker. In the step 208, the process 200 may determine which test cases will be currently tested.

In the step 210, the process 200 may apply a series of rules to each test case. In the step 212, the process 200 may apply a rule on a current test case and calculate a score. In the step 214, the process 200 may determine if more rules are needed to be applied to the current test case. If more rules are needed to be applied, the process 200 may move back to the step 210. If not, then the process 200 may move to the step 216.

In the step 216, the process 200 may calculate a total test case score. In the step 218, the process may determine if the score for the test case is higher than a predetermined value (e.g., threshold). If so, the process 200 may move to the step 220. If not, the process 200 may move to the step 222. In the step 220, the process 200 may flag the test case as good. In the step 222, the process 200 may determine if more test cases are needed to be tested. If so, the process 200 may move to the step 208. If not, the process 200 may move to the step 224. In the step 224, the process 200 may return or present a list of appropriate test cases to a test planner. In general, the test cases flagged as good are presented to the planner. In the step 226, the process 200 may terminate.

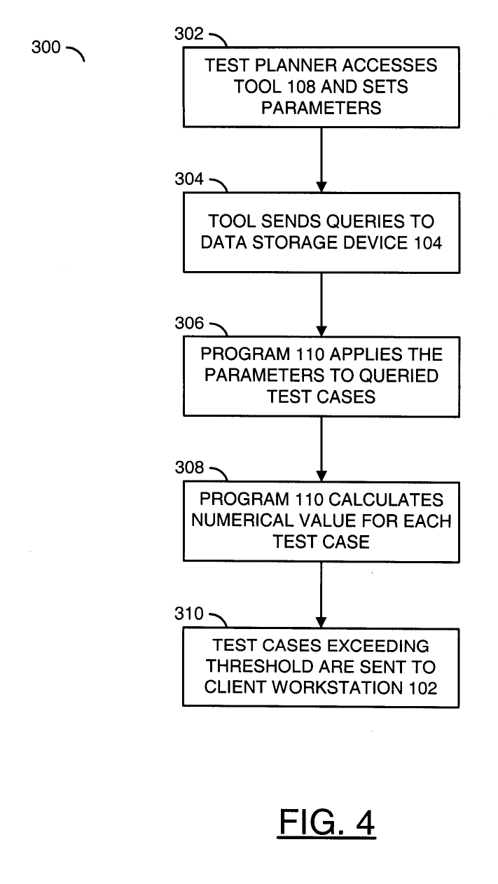

Referring to FIG. 4, a flow diagram of a process 300 is shown. The process 300 generally comprises a step 302, a step 304, a step 306, a step 308, and a step 310. The steps 302-310 may be implemented as steps, states of a state diagram, processes, subroutines, or other type of steps and/or states and/or processes. In the step 302, a test planner may access the tool 108 and set the rules (or parameters). In the step 304, the tool may send a set of queries to the data storage device 104. In one example, the queries may test a particular group of test cases within the data storage device 104. The queries may relate to an aspect of the test cases. In the step 306, the program 110 may apply the set of rules to the test cases queried by the test planner. In the step 308, the program 110 may calculate a numerical value for each test case queried. In the step 310, the test cases exceeding a threshold score (or value) may be returned to the test planner for use in testing.

The process 300 may evaluate all of the rules defined, evaluate each test case being queried, and report a score (e.g., appropriateness level) for each test case. If the score exceeds a certain threshold (e.g., predetermined value), then the test case may be reported as a good (or positive) test case. The predetermined value may be adjusted by the test planner. In one example, the predetermined value may be adjusted lower if the evaluation of the test cases results in a small number of returns (e.g., an aggressive evaluation). In another example, the predetermined value may be adjusted higher if the evaluation of the test cases results in a large number of returns (e.g., a conservative evaluation). Within a testing organization, there may be rules that are standardized. For example, a higher number may be used to indicate an aggressive evaluation.

In one example, a client workstation 102 with the tool 108 incorporated into a test case management software may be used by a test planner. The test planner may access the tool 108, and may want to know which test cases should be used. In such a case, the test planner may query a group of test cases. The test planner may then tell the program 110 to apply the rules (e.g., parameters). For each test case that may be returned by the general query, the rules may be evaluated, and a score may be calculated. The results may be returned to the test planner. For each test case, if the test case score exceeds the threshold, then the test case will be indicated or highlighted (e.g., by color-coding, ranking of score, etc.) and returned to the test planner.

In an example operation, when a user initiates a query with the tool 108, the query may search the database of test case information. The query may implement a generally user-controlled way to filter data a particular user is looking at. In one example, the queries may be a basic pre-filter of the test case information, before the scores are generated. The queries may help the tool 108 generate scores on data representing less than an entire library of test case information in order to improve efficiency. The data stored in an initial query may look at the test routines being performed (e.g., test cases). The execution history of particular tests may also be stored in the database. The tool 108 may be concerned with the history of previously executed test cases. The tool 108 may make comparisons to such a history to provide analysis of the data that may be used by the tester/test planner.

In an example operation, a user may present queries relating to test case information for a list of all test cases with a particular label (e.g., “GUI, graphical user interface”). Such labeling may be provided via a field/attribute tag stored within the test case data. The tool 108 may then use the results of the query and execute the scoring mechanism. The results may be in the form of a list of test cases that are GUI test cases). The tool 108 may compare the scores of the test cases with a list of rules. The tool 108 may then return the results of the comparisons to the user, marking test cases as “appropriate” to run if a score is over a predetermined value (e.g., 5 points or some other arbitrary number based on rule definitions). In one example, the list returned to the user may be formatted to either show just the appropriate test cases that also fit with the original query. The list may also show all of the test cases that fit the original query, and in some way indicate (e.g., using icon, a color-coded row, etc.) which tests were “appropriate”.

The functions performed by the diagrams of FIGS. 3-4 may be implemented using a conventional general purpose processor, digital computer, microprocessor, microcontroller, RISC (reduced instruction set computer) processor, CISC (complex instruction set computer) processor, signal processor, central processing unit (CPU), arithmetic logic unit (ALU), video digital signal processor (VDSP) and/or similar computational machines, programmed according to the teachings of the present specification, as will be apparent to those skilled in the relevant art(s). Appropriate software, firmware, coding, routines, instructions, opcodes, microcode, and/or program modules may readily be prepared by skilled programmers based on the teachings of the present disclosure, as will also be apparent to those skilled in the relevant art(s). The software is generally executed from a medium or several media by one or more of the processors of the machine implementation.

The present invention may also be implemented by the preparation of ASICs (application specific integrated circuits), Platform ASICs, FPGAs (field programmable gate arrays), PLDs (programmable logic devices), CPLDs (complex programmable logic device), sea-of-gates, RFICs (radio frequency integrated circuits), ASSPs (application specific standard products) or by interconnecting an appropriate network of conventional component circuits, as is described herein, modifications of which will be readily apparent to those skilled in the art(s).

The present invention thus may also include a computer product which may be a storage medium or media and/or a transmission medium or media including instructions which may be used to program a machine to perform one or more processes or methods in accordance with the present invention. Execution of instructions contained in the computer product by the machine, along with operations of surrounding circuitry, may transform input data into one or more files on the storage medium and/or one or more output signals representative of a physical object or substance, such as an audio and/or visual depiction. The storage medium may include, but is not limited to, any type of disk including floppy disk, hard drive, magnetic disk, optical disk, CD-ROM, DVD and magneto-optical disks and circuits such as ROMs (read-only memories), RAMs (random access memories), EPROMs (electronically programmable ROMs), EEPROMs (electronically erasable ROMs), UVPROM (ultra-violet erasable ROMs), Flash memory, magnetic cards, optical cards, and/or any type of media suitable for storing electronic instructions.

As used herein, the term “simultaneously” is meant to describe events that share some common time period but the term is not meant to be limited to events that begin at the same point in time, end at the same point in time, or have the same duration.

While the invention has been particularly shown and described with reference to the preferred embodiments thereof, it will be understood by those skilled in the art that various changes in form and details may be made without departing from the scope of the invention.

1. A method for evaluating one or more tests comprising the steps of:
(A) generating one or more queries relating to an aspect of said one or more tests;
(B) comparing results received from said one or more queries to scoring data stored in one or more databases;
(C) generating a score in response to said comparison; and
(D) determining if a first of said tests should be run based on whether said score is above a predetermined value.

2. The method according to claim 1, wherein step (B) further comprising the sub-step of:
performing said comparison on two or more of said tests.

3. The method according to claim 1, wherein said predetermined value is adjustable by a user.

4. The method according to claim 3, wherein said predetermined value is adjusted lower if said evaluation of said tests is aggressive.

5. The method according to claim 3, wherein said predetermined value is adjusted higher if said evaluation of said tests is conservative.

6. The method according to claim 1, wherein said one or more databases are stored in a data storage device.

7. The method according to claim 6, wherein said data storage device is remotely located from a computer.

8. The method according to claim 7, wherein said computer comprises a client workstation.

9. The method according to claim 1, wherein step (D) determines an appropriateness level in response to a set of parameters presented by a user.

10. The method according to claim 9, wherein said set of parameters is configurable.

11. The method according to claim 1, wherein said tests comprise reliability tests configured to test a design.

12. A system comprising:
a first circuit configured to generate one or more queries relating to an aspect of one or more tests;
a second circuit configured to (i) receive said one or more queries, (ii) apply a set of rules to said one or more tests in response to said one or more queries, and (iii) send an evaluation of said one or more tests to said first circuit; and
a network configured to connect said first circuit and said second circuit.

13. The system according to claim 12, wherein said first circuit comprises a computer.

14. The system according to claim 12, wherein said second circuit comprises a data storage device.

15. The system according to claim 14, wherein said data storage device is configured to store one or more databases.

16. The system according to claim 12, wherein said evaluation comprises generating an appropriateness level for each one or more test cases.

17. The system according to claim 16, wherein said appropriateness level is generated in response to one or more rules applied to said one or more test cases.
